(19) United States
(12) Patent Application Publication
(10) Pub. No.: US 2022/0236418 A1
(43) Pub. Date: Jul. 28, 2022

(54) LIDAR SYSTEM COMPRISING AN INTERFERENTIAL DIFFRACTIVE ELEMENT AND LIDAR IMAGING METHOD

(71) Applicants: THALES, COURBEVOIE (FR); COMMISSARIAT A L'ENERGIE ATOMIQUE ET AUX ENERGIES ALTERNATIVES, PARIS (FR)

(72) Inventors: François DUPORT, PALAISEAU (FR); Frédéric VAN DIJK, PALAISEAU (FR); Philippe BOIS, PALAISEAU (FR)

(21) Appl. No.: 17/615,029

(22) PCT Filed: May 29, 2020
(86) PCT No.: PCT/EP2020/065037

§ 371 Date: Nov. 29, 2021

(30) Foreign Application Priority Data
May 29, 2019 (FR) 1905441

(51) Int. Cl. G01S 17/34; G01S 17/42; G01S 17/894; G01S 7/481; G02F 1/29

(52) U.S. Cl. CPC G01S 17/34; G01S 17/42; G02F 1/292; G01S 7/4817; G01S 17/894

(57) ABSTRACT

A LIDAR system includes at least one laser source and an optical detection system for detecting radiation emitted by the laser source and reflected by a scene to be observed, wherein the laser source is designed to emit simultaneously at n>1 separate wavelengths λᵢ, i∈[1,n]; the LIDAR system also comprises a diffractive optical component configured to direct the radiation emitted by the laser source to the scene to be observed in a different direction for each the wavelength in a simultaneous manner, the directions being located in a same plane xz; and the optical detection system comprises at least one photodiode arranged so as to be illuminated by the radiation reflected by the scene to be observed, as well an optical system, which is configured to direct laser radiation, emitted by the or another laser source and having a wavelength λ₀ which is different from the n wavelengths λᵢ, to the one or more photodiodes, such that the one or more photodiodes generate a signal comprising the beats of the wavelengths of the radiation reflected by the scene to be observed with the radiation having the wavelength λ₀.

### TECHNICAL FIELD

The invention relates to the field of LIDAR detection.

### PRIOR ART

LIDAR systems use light to measure the distance and sometimes the velocity of objects or targets. Like radar, LIDAR systems require that the space be probed by an optical beam to reproduce a two- or three-dimensional image of the observed scene. In general, this involves scanning the space with an optical beam. This results in a scanning time that can be potentially harmful for some applications. Indeed, while the beam is directed in a given direction, the other directions of the scene are not observed. In addition, the area covered by the LIDAR and the speed of its coverage depend on the solutions chosen to build the Lidar. A compromise must be made between several parameters: the distance covered by the LIDAR, which depends on the power of the laser used, the solid angle covered by the LIDAR, which depends on the type of application (alerted surveillance or escort for example), and finally the speed with which the LIDAR probes the covered area (which depends in general on the type and velocity of the sought targets).

In the context of LIDAR systems, the scanning of space by an optical beam is often a limiting parameter. To achieve this scanning three solutions exist:

The first solution is mainly mechanical. It consists in using a laser transmitter and receiver pairing, which both point in the same direction. The assembly is mobile in order to scan the space. It can also be formed by one or more mobile mirrors that make it possible to orient the light beam of the laser transmitter and to direct the signal reflected on the photodetector. These scanning devices can be miniaturized as necessary using optical MEMS. Although this solution has the advantage of not being dependent on the wavelength used for the Lidar, it does, however, require a precise alignment of the optical system, and has a high sensitivity to the vibrations and accelerations, which strongly limits the possible applications.

The second solution lies in using an interferential optical system to deflect the optical beam. The principle is then to use an interferential optical assembly to direct the light in a given direction in space according to the wavelength. In general, the optical signal is separated into several points and a phase shift is imposed between these points. The interference between the signals from these points is constructive in a given direction. By varying the phase shift between these points, either by using phase modulators or by varying the wavelength of the laser used, the system scans the direction pointed by the optical beam. This solution has the advantage of not relying on any moving parts but imposes certain constraints on the speed of laser tuning and its reproducibility. Moreover, it is not possible to obtain a large angular scan on two axes, which requires the use of several interferential systems and switching their use to obtain the desired scan. These methods are known to a person skilled in the art (see US2018/052378 and DE102015225863).

The third solution lies in using a linear photodiode array. Each photodiode is in charge of detecting the optical signal coming from a given direction of the observed scene. This solution makes it possible to observe only one axis of the scene, either a row or a column of the image to be produced. In addition, the solutions based on a matrix of photodetectors do not allow for a measurement of the velocity of the objects.

It is also known to use a combination of these solutions. For example, the systems in US 2017/0269215A1 and WO2017/132704A1 use linear photodetector arrays mounted on a moving turret.

However, all existing beam scanning solutions are either potentially sensitive to vibrations for mechanical solutions, or propose rather inhomogeneous scanning angles. In addition, all these solutions, by the very nature of the scan, only allow each direction in space to be observed intermittently. There is thus a compromise to be found depending on the precision of the scan, its speed, and its amplitudes.

The invention aims to mitigate some of the problems and constraints associated with angular scanning of the laser beam in a LIDAR system.

To this end, the invention relates to a system as described by the claims.

The invention also relates to a method for using such a system.

### SUMMARY OF THE INVENTION

To this end, the invention relates to a LIDAR system comprising at least one laser source and an optical detection system for detecting radiation emitted by the laser source and reflected by a scene to be observed, characterized in that:

the laser source is adapted for emitting simultaneously at n>1 separate wavelengths λᵢ, i∈[1,n];

the LIDAR system also comprises a diffractive optical component configured to direct the radiation emitted by the laser source to the scene to be observed in a different direction for each said wavelength in a simultaneous manner, said directions being located in a same plane xz; and

the optical detection system comprises at least one photodiode arranged so as to be illuminated by the radiation reflected by the scene to be observed, as well as an optical system, which is configured to direct laser radiation, emitted by said or another laser source and having a wavelength λ₀ which is different from said n wavelengths λᵢ, to the one or more photodiodes, such that the one or more photodiodes generate a signal comprising the beats of the wavelengths of the radiation reflected by the scene to be observed with the radiation having the wavelength λ₀.

According to particular modes of the invention:

the optical detection system comprises a plurality of photodiodes arranged along an axis y not parallel to the plane xz and a convergent lens designed to associate with each of the photodiodes the light rays coming from the scene to be observed and which form with the y-axis an angle comprised in a determined range, which is different for each photodiode;

the diffractive optical component is an integrated optical circuit comprising waveguides opening out on output faces of the integrated optical circuit and lenses diverging at the output faces;

the laser system is designed to emit at the wavelength λ₀, said LIDAR system comprising an interference filter designed to select and spatially separate radiation having the wavelength λ₀ from the laser radiation emitted by the laser system;

the LIDAR system comprises an optical component configured to wavelength-shift a spectral component of the laser radiation to obtain λ₀;

the laser system is a pulse mode-locked laser;

the laser system is a continuous wave laser with a fixed phase relationship between the n wavelengths generated by the laser system, further comprising means designed to perform frequency modulation of the n separate wavelengths, said modulation being less than 1 GHz, preferably less than 100 MHz, preferably less than 10 MHz;

the LIDAR system comprises means for processing the one or more signals generated by the one or more photodiodes, designed to determine at least one parameter among the radial velocity, the distance, and the position of at least one reflecting object present in the scene to be observed; and

the one or more photodiodes have a spectral bandwidth greater than 8 GHz, preferably 10 GHz, and more preferably 12 GHz.

The invention also relates to a method for using a LIDAR system comprising a laser system, a diffractive optical component and an optical detection system comprising at least one photodiode arranged so as to be illuminated by the radiation reflected by the scene to be observed, said method comprising the following steps:
a. emitting, simultaneously, radiation at at least n>1 separate wavelengths λᵢ, i∈[1,n] by the laser system;
b. diffracting, by the diffractive element, the radiation emitted by the laser source to the scene to be observed in a different direction for each said wavelength in a simultaneous manner, said directions being located in a same plane xz;
c. illuminating, by means of an optical system of the optical detection system, the one or more photodiodes with laser radiation emitted by said or another laser source and having a wavelength λ₀ different from said n wavelengths λᵢ;
d. and generating, by the one or more photodiodes, a signal comprising the beats of the wavelengths of the radiation reflected by the scene to be observed with the radiation having the wavelength λ₀
generating, by the one or more photodiodes, a signal comprising the beats

According to a particular embodiment, this method of use a final step of determining the radial velocity and the position of at least one reflecting object present in the scene to be observed by means for processing the one or more signals generated by the one or more photodiodes.

### BRIEF DESCRIPTION OF THE FIGURES

Further features, details and advantages of the invention will become apparent from reading the description made with reference to the annexed drawings given by way of example and which show, respectively:

FIG. 1, a schematic view of the LIDAR system of the invention according to a first embodiment of the invention.

FIG. 2A, FIG. 2B and FIG. 2C, schematic two-dimensional front, side, and top views, respectively, of the LI DAR system of the first embodiment of the invention.

FIG. 3, a schematic diagram of the operation of a diffractive optical component of the LIDAR system of the first embodiment of the invention.

FIG. 3B, the profile of the electromagnetic field within the THz electromagnetic cavity with Tamm modes according to the second embodiment of the invention.

FIG. 4, a schematic diagram of the operation of the optical detection system of the LIDAR system of the first embodiment of the invention.

### DETAILED DESCRIPTION

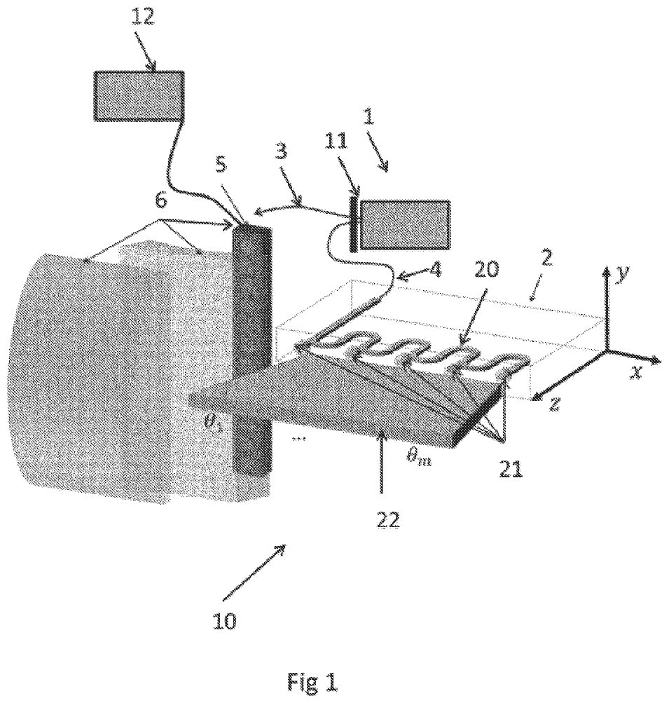

FIG. 1 illustrates a first embodiment of the invention. In this embodiment, the LIDAR system 10 comprises a pulse mode-locked laser system 1. This laser system 1 emits radiation comprising n>1 wavelengths, for example thirteen separate wavelengths λᵢ₀, i∈[0,12], corresponding to 13 modes, the wavelength of the first mode (n=0) being between 1 and 2 μm. The free spectral range of the laser being f₀=1 GHz, the modes are spaced at 1 GHz. In the embodiment shown in FIG. 1, the laser system 1 comprises an interference filter or a matched filtering system 11 to select and spatially separate radiation having the wavelength λ₀ from the radiation emitted by the laser system. In this embodiment, the interference filter 11 is a Bragg filter. This filtering thus makes it possible to obtain a laser beam 3 comprising a single mode at a wavelength λ=λ₀ and another laser beam 4 comprising 12 modes and 12 separate wavelengths λᵢ, i∈[1,n], all greater than λ₀.

In another embodiment, the laser system emits radiation comprising n>1 wavelengths λᵢ, i∈[1,n] and the laser radiation 3 of wavelength λ₀ is emitted by a different laser of the laser system 1, λ₀ being strictly less than or greater than the wavelengths λᵢ, i∈[1,n] emitted by the laser system and comprised in the beam 4. In another embodiment, the laser system comprises an optical component configured to wavelength-shift a laser mode λᵢ, i∈[1,n] emitted by the laser system to obtain the beam 3 at a wavelength λ=λ₀, λ₀ being strictly less than (or greater than) the wavelengths λᵢ, i∈[1,n] emitted by the laser system and comprised in the beam 4. In yet another embodiment of the invention, λ₀ is simply different from the wavelengths λᵢ, i∈[1,n].

The LIDAR system 10 comprises a diffractive optical component 2 configured to direct the radiation 4 emitted by the laser source to the scene to be observed in a different direction for each said wavelength in a simultaneous manner, said directions being located in a same plane xz. In a non-limiting example, the diffractive optical element is an integrated optical circuit comprising waveguides 20 with an effective index of 1.5 opening out on output faces of the integrated optical circuit and divergent lenses 21 at the output faces. The outputs are aligned and spaced 15 μm apart along the x-axis and each output has an optical delay of 2 cm relative to the previous output. The output radiation 4 from the laser system 1 is guided through an optical fiber to the integrated optical circuit. Due to the interference between the beams obtained at the output of the diffractive optical component 2, each wavelength λᵢ emitted by the laser system is radiated simultaneously in a direction dᵢ different from the plane xz so as to cover an angle of about 90°. In the embodiment shown in FIG. 1, each wavelength λ₍ᵢ₊₁₎ i∈[1,11] is thus radiated in a direction of the plane xz making an angle of 7.5° with respect to the direction in which the wavelength λᵢ is radiated. The resulting laser radiation 22 thus makes it possible to sample the space of the observed scene due to the spatial separation of the wavelengths. In another embodiment, the diffractive optical component is a diffraction grating in amplitude or phase reflection or transmission.

The LIDAR system further comprises an optical detection system 6 comprising at least one photodetector. In the embodiment of FIG. 1, the detection system comprises a plurality m of photodiodes 5 arranged along an axis y not parallel and preferably perpendicular to the plane xz and at least one converging lens designed to associate with each of the photodiodes j∈[1,m] the light rays coming from the reflection of the radiation 22 by one or more objects of the scene to be observed and which form with the y-axis an angle ϕⱼ, j∈[1,m] comprised in a determined range, which is different for each photodiode. In the embodiment of FIG. 1, the y-axis is perpendicular to x and z. Thus, in the embodiment of FIG. 1, each photodiode receives radiation from objects in the scene to be observed corresponding to different elevations (positions along the y-axis).

The optical detection system 6 further comprises an optical system 7 (not shown in FIG. 1) configured to direct the laser radiation 3 having a wavelength λ₀ different from said n>1 wavelengths λᵢ of the radiation 4 to the photodetector(s). This optical system may be, for example, an optical fiber into which the radiation 3 passing through the interference filter 11 is injected, and which carries this radiation to the one or more photodiodes. In another embodiment, this optical system 7 is a planar waveguide. In one embodiment, the optical system is a mirror system. This embodiment is less advantageous because the mirror system is more sensitive to vibrations. Thus, the one or more photodiodes generate a signal comprising the beats of the wavelengths of the radiation reflected by the scene to be observed with the radiation having the wavelength λ₀. The effect of these beats being that, for each wavelength—and thus for each direction of the plane xz—the photodiode signal is modulated at a different frequency, in the GHz range.

In the embodiment of FIG. 1, means 12 for processing the signals generated by the photodiodes are designed to determine at least one parameter among the radial velocity and the position of reflective objects present in the scene to be observed from the electrical spectra of the radiation captured by the photodiodes. The position of an object is calculated by determining the elevation of the object (determined by the angle λⱼ that the object forms with the y-axis and therefore by the photodiode j that generates the spectrum), the direction of the object (at what frequency i×f₀ is a spectral component found) and the distance (given by the time of flight of the laser pulse). The radial velocity of a reflecting object is determined by the frequency shift of a component of the electrical spectrum with respect to the frequencies i×f₀, i∈[1,n].

In the embodiment shown in FIG. 1, assume that an object to be detected reflects the beam rays 22 that are emitted in the direction dᵢ corresponding to the wavelength λᵢ and that this reflection results in light rays making an angle ϕ=ϕⱼ with the y-axis. The optical detection system allows these light rays to be captured on the photodiode j, which will then generate a signal comprising the beats of the wavelengths of the reflected radiation with the radiation 3 having the wavelength λ₀. From this signal, the processing means are configured to obtain the electrical spectrum of the radiation captured by the photodiode. The electrical spectrum will then comprise a spectral component having the frequency i×f₀. The velocity of this object is determined by the frequency shift related to the Doppler effect.

By analyzing, for all photodiodes j∈[1,m], the spectrum located around the frequencies i×f₀, i∈[1,n], it is possible to reconstruct the observed scene in a single measurement. Unlike LIDAR systems using interference devices known in the prior art, the embodiment of FIG. 1 thus allows for the simultaneous observation of multiple directions of a scene and thus allows the constraints and disadvantages associated with the scanning of the laser beam to be avoided. Furthermore, the LIDAR system of the embodiment of FIG. 1 has no moving parts, which makes the radial velocity and position measurements robust to vibrations and high accelerations.

In the embodiment shown in FIG. 1 the photodiodes have a detection spectral bandwidth of at least 13 GHz, which allows the simultaneous detection on each photodiode of the twelve frequency components at n×f₀, ne[1,12] spaced at 1 GHz, these components corresponding to the beats of the radiation having the wavelength λ₀ with the twelve wavelengths λᵢ radiated in different directions dᵢ and reflected by possible objects.

The radial velocity resolution is determined by the frequency spacing between two frequency components, i.e. by the free spectral range f₀. Also, the maximum frequency shift due to the measurable Doppler effect is

$$Δ {f}_{max} = \frac{{f}_{0}}{2} \qquad [ Math 1 ]$$

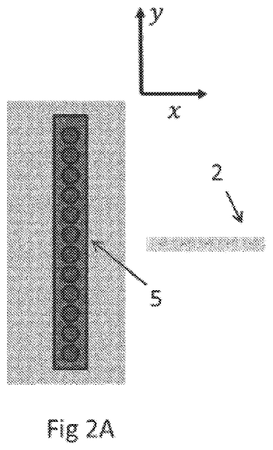

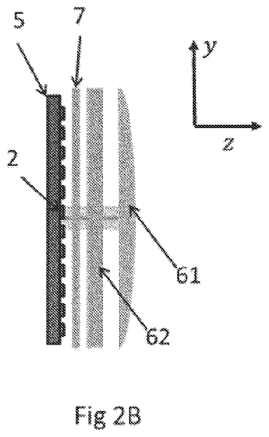

FIG. 2 illustrates a schematic two-dimensional front, side, and top view of the LIDAR system of FIG. 1. As previously mentioned, the photodiodes 5 of the detection optical system are aligned along a y-axis, perpendicular to the x-axis, which is the axis along which the outputs of the diffractive optical component 2 are aligned. In this embodiment, the optical detection system also comprises a divergent cylindrical lens 62 to capture a maximum of flux on the photodiodes. The optical system 7 for directing the laser radiation 3 having the wavelength λ₀ to the photodiode is a mirror reflecting at this wavelength.

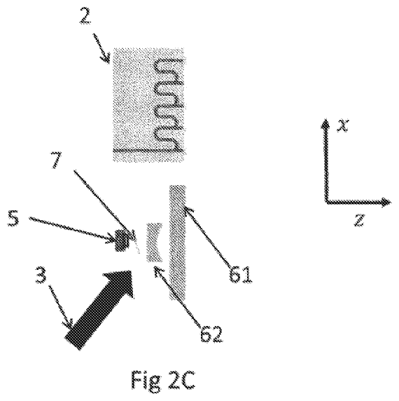

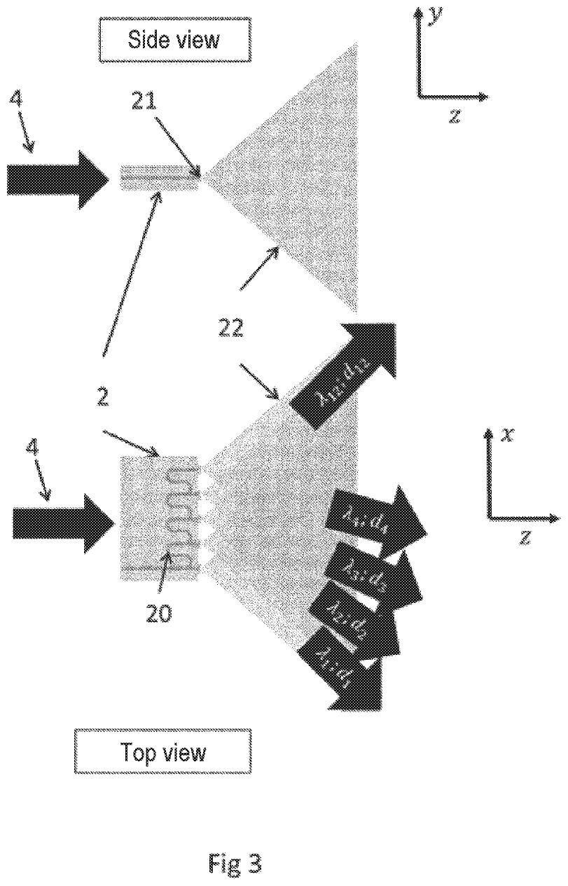

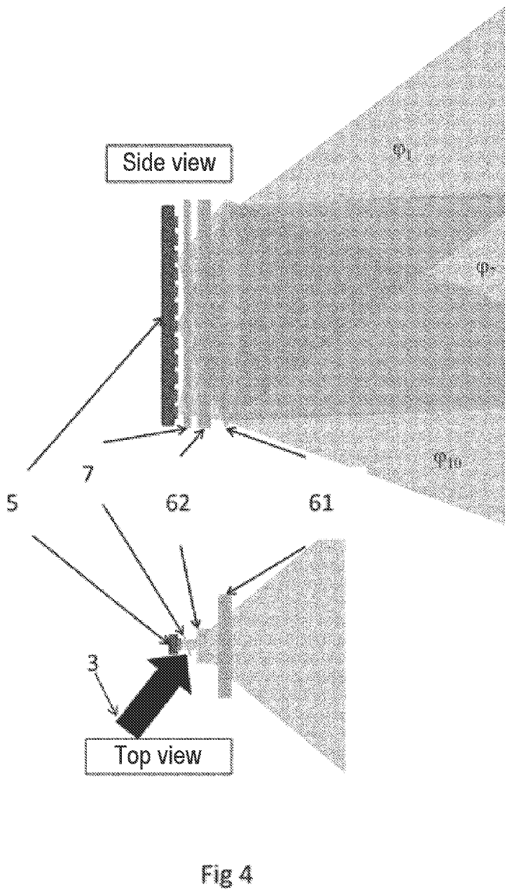

FIG. 3 shows a schematic diagram of the operation of the diffractive optical component (here an integrated optical circuit) 2 of the LIDAR system according to the embodiment of FIG. 1. In FIG. 4, a side view and a top view of the diffractive optical component 2 are shown. In the integrated optical circuit 2, the waveguides 20 open out on output faces with diverging lenses 21. The outputs are aligned and spaced 15 μm apart along the x-axis and each output has an optical delay of 2 cm relative to the previous output. The top view makes it possible to see that the laser beam 4 comprising twelve wavelengths λᵢ, i∈[1,12] is diffracted at the output of the integrated optical circuit so as to obtain a radiation 22 in which each wavelength λᵢ is radiated simultaneously in a direction dᵢ, i∈[1,12] different from the plane xz.

In the embodiment where the laser system 1 emits radiation comprising n>1 wavelengths λᵢ, i∈[1,n], the diffractive optical component is configured to direct the radiation 4 emitted by the laser source to the scene to be observed in a different direction dᵢ, i∈[1,n] for each said wavelength in a simultaneous manner, said directions being located in a same plane xz.

Lastly, FIG. 4 illustrates a schematic diagram of the operation of the optical detection system of the LIDAR system according to the embodiment of FIG. 1. In FIG. 4, a side view and a top view are shown. The side view makes it possible to see that the cylindrical converging lens 61 associates with each of the m photodiodes 5 the light rays coming from the reflection of the radiation 3 by one or more objects of the scene to be observed and which form with the y-axis an angle ϕⱼ, j∈[1,m] comprised in a determined range, which is different for each photodiode. In this embodiment, the optical detection system comprises twelve photodiodes having a detection spectral bandwidth of 13 GHz. Each of the photodiodes therefore detects objects at different elevations. The divergent cylindrical lens 62 allows the best coverage of the observed scene. The mirror 7 is reflective at the wavelength λ₀ of the radiation 3 and allows the laser radiation 3 to be directed to the photodiodes 5, which laser radiation generates a signal comprising the beats of the wavelengths of the radiation reflected by the scene to be observed with the radiation 3 having the wavelength λ₀.

In another embodiment, the laser system is a continuous wave laser emitting at n>1 wavelengths λᵢ, i∈[1,n] with a fixed phase relationship between the n wavelengths generated by the laser system. In this embodiment, the laser system further comprising means designed to perform frequency modulation of the n separate wavelengths, said modulation being less than 1 GHz, preferably less than 100 MHz, preferably less than 10 MHz. To realize this modulation, several components can be used: they can be an acousto-optical modulator or a double Mach Zehnder modulator, such as those used for coherent optical transmissions (also called an IQ modulator) and which is polarized so as to apply an optical frequency shift. This frequency modulation makes it possible to determine, at the end of a final step, the radial velocity of at least one reflecting object present in the scene to be observed by the Doppler effect.

In another embodiment, the optical detection system comprises a single photodiode. In this embodiment, it is therefore possible to detect optical signals coming from only one axis of the scene. However, it is still possible to simultaneously observe multiple directions of the scene due to the wavelengths λᵢ, i∈[1,n] of the radiation 4 emitted simultaneously in the directions dᵢ at the output of the diffractive optical component 2.

1. A LIDAR system comprising at least one laser source and an optical detection system for detecting radiation emitted by the laser source and reflected by a scene to be observed, wherein:
the laser source is designed to emit simultaneously at n>1 separate wavelengths λᵢ, i∈[1,n];
the LIDAR system also comprises a diffractive optical component configured to direct the radiation emitted by the laser source to the scene to be observed in a different direction for each said wavelength in a simultaneous manner, said directions being located in a same plane xz; and
the optical detection system comprises at least one photodiode arranged so as to be illuminated by the radiation reflected by the scene to be observed, as well as an optical system, which is configured to direct laser radiation, emitted by said or another laser source and having a wavelength λ₀ which is different from said n wavelengths λᵢ, to the one or more photodiodes, such that the one or more photodiodes generate a signal comprising the beats of the wavelengths of the radiation reflected by the scene to be observed with the radiation having the wavelength λ₀.

2. The LIDAR system as claimed in claim 1, wherein the optical detection system comprises a plurality of photodiodes arranged along an axis y not parallel to the plane xz and a convergent lens designed to associate with each of the photodiodes the light rays coming from the scene to be observed and which form with the y-axis an angle comprised in a determined range, which is different for each photodiode.

3. The LIDAR system as claimed in claim 1, wherein the diffractive optical component is an integrated optical circuit comprising waveguides opening out on output faces of the integrated optical circuit and divergent lenses at the output faces.

4. The LIDAR system as claimed in claim 1, wherein the laser system is designed to emit at the wavelength λ₀, said LIDAR system comprising an interference filter designed to select and spatially separate radiation having the wavelength λ₀ from the laser radiation emitted by the laser system.

5. The LIDAR system as claimed in claim 1, comprising an optical component configured to wavelength-shift a spectral component of the laser radiation to obtain λ₀.

6. The LIDAR system as claimed in claim 1, wherein the laser system is a pulse mode-locked laser.

7. The LIDAR system as claimed in claim 1, wherein the laser system is a continuous wave laser with a fixed phase relationship between the n wavelengths generated by the laser system, further comprising means designed to perform frequency modulation of the n separate wavelengths, said modulation being less than 1 GHz, preferably less than 100 MHz, preferably less than 10 MHz.

8. The LIDAR system as claimed in claim 1, comprising means for processing the one or more signals generated by the one or more photodiodes, designed to determine at least one parameter among the radial velocity, the distance, and the position of at least one reflecting object present in the scene to be observed.

9. The LIDAR system as claimed in claim 1, wherein the one or more photodiodes have a spectral bandwidth greater than 8 GHz, preferably 10 GHz, and more preferably 12 GHz.

10. A method for using a LIDAR system comprising a laser system, a diffractive optical component and an optical detection system comprising at least one photodiode arranged so as to be illuminated by the radiation reflected by the scene to be observed, said method comprising the following steps:
a. emitting, simultaneously, radiation at at least n>1 separate wavelengths λᵢ, i∈[1,n] by the laser system;
b. diffracting, by the diffractive element, the radiation emitted by the laser source to the scene to be observed in a different direction for each said wavelength in a simultaneous manner, said directions being located in a same plane xz;
c. illuminating, by means of an optical system of the optical detection system, the one or more photodiodes with laser radiation emitted by said or another laser source and having a wavelength λ₀ different from said n wavelengths λᵢ; and
d. generating, by the one or more photodiodes, a signal comprising the beats of the wavelengths of the radiation reflected by the scene to be observed with the radiation having the wavelength λ₀.

11. A method for imaging by a LIDAR system as claimed in claim 10, comprising a final step of determining the radial velocity and the position of at least one reflecting object present in the scene to be observed by means for processing the one or more signals generated by the one or more photodiodes.
